(19) United States
(12) Patent Application Publication
(10) Pub. No.: US 2018/0037403 A1
(43) Pub. Date: Feb. 8, 2018

(54) SHIPPING CONTAINER

(71) Applicant: JAPAN-CHINA EAST NORTH PRODUCTS CO., LTD., Tottori (JP)

(72) Inventor: Kenichi KONDOH, Tottori (JP)

(21) Appl. No.: 15/552,393

(22) PCT Filed: Jun. 15, 2016
(86) PCT No.: PCT/JP2016/067720

§ 371 Date: Aug. 21, 2017

(30) Foreign Application Priority Data
Jun. 15, 2015 (JP) 2015-119903

(51) Int. Cl. B65D 88/10; E06C 1/34; B65D 90/08

(52) U.S. Cl. CPC B65D 88/10; B65D 90/08; E06C 1/34

(57) ABSTRACT

A shipping container includes: a bottom plate onto which cargo is to be placed, columns vertically extending from the bottom plate, and top plates detachably supported by the columns. Since the top plates are detachable from the columns, it is possible to smoothly load long objects into the shipping container from above the container, by removing the top plates in advance. When the loading is completed, the top plates are attached back to the columns again to reinforce the columns, thereby ensuring the strength of the shipping container as a whole. A plurality of these shipping containers can therefore be stacked one on another in a container ship, in the same manner as ordinary shipping containers.

### TECHNICAL FIELD

The present invention relates to a shipping container for transporting cargo. More particularly, the present invention relates to a shipping container suitable for loading long objects such as lumber.

### BACKGROUND ART

When transporting cargo in a shipping container, loading and unloading of the cargo into and out of the shipping container is carried out, as shown in the below-identified Patent Document 1 for example, through the opening formed by opening doors at the rear end of the shipping container (see FIG. 1 of Patent Document 1). In this case, a transport vehicle such as a forklift is used for the loading and unloading of the cargo. However, when transporting long objects such as lumber or steel materials, as cargo, there is a problem that a bundle of a plurality of such long objects may break during the loading and unloading thereof, and the end portions of the scattered long objects may come into contact with the inner surfaces of the shipping container, to cause damage to the inner surfaces or to the long objects themselves. In addition, loading and unloading of a large number of long objects into and out of the shipping container through the doors is a complicated operation, which consumes time and cost.

In view of this, it has been proposed to install a cargo bed for long objects to a transportation vehicle, as shown in the below-identified Patent Document 2, for carrying out the transportation of long objects. This cargo bed includes a plurality of fall prevention columns vertically extending from both the right and left sides of its floor surface, at positions bilaterally symmetrical to each other (See e.g., FIG. 1 of Patent Document 2). The fall prevention columns serve to prevent the falling of the long objects loaded on the floor surface from the right and left sides of the floor surface. Since no top plate is provided on top of the fall prevention columns, the loading of the long objects can be carried out directly from above the cargo bed (see FIG. 6 in Patent Document 2).

### PRIOR ART DOCUMENTS

### Patent Documents

Patent Document: 1 JP 11-60187 A
Patent Document: 2 JP 2015-696 A

### SUMMARY OF THE INVENTION

### Problems to be Solved by the Invention

However, the cargo bed for long objects disclosed in Patent Document 2 is for use in a transportation vehicle such as a truck, and thus, in order to load long objects loaded on the cargo bed for long objects, into a container ship, it is necessary to unload the long objects from the cargo bed and to reload them into a shipping container. This reloading operation is extremely complicated, and causes an increase in the cost as a result thereof. In addition, there is a potential risk for other problems such as the occurrence of damage in the long objects during the reloading.

Accordingly, an object of the present invention is to provide a shipping container into which long objects such as lumber can be efficiently loaded.

### Means for Solving the Problems

In order to solve the above mentioned problems, the present invention has adopted the following constitution:

a shipping container including: a bottom plate onto which cargo is to be placed; columns vertically extending from the bottom plate; and a top plate detachably supported by the columns.

Since the top plate in this shipping container is detachable from the columns, it is possible to smoothly load cargo from above the shipping container, by detaching and removing the top plate when loading the cargo into the shipping container. When the loading is completed, the top plate is attached back to the columns again. By attaching the top plate to the columns, the columns, which are separately and vertically disposed, are integrally joined together by the top plate, thereby ensuring the strength of the shipping container as a whole. Therefore, a plurality of such shipping containers can be stacked one on top of another in a container ship, in the same manner as ordinary shipping containers.

Preferably, the top plate of this shipping container is formed with one or more than one insertion recess into which a jig or jigs used to attach and detach the top plate to and from the columns are inserted. By forming such insertion recess or recesses in the top plate, a jig or jigs (such as forks of a forklift) can be inserted into the insertion recess or recesses, to allow for easily attaching and detaching the top plate.

In each of the above-described constitutions, at least one of the plurality of columns, which support the top plate, may be in the shape of a ladder. Such a ladder-shaped column allows an operator to climb up this ladder-shaped column to the upper portion of the shipping container, and to confirm the state of the loaded cargo. All of the columns need not be in the shape of a ladder. For example, the columns disposed at three locations on each side, namely at the foremost portion, central portion, and rearmost portion on each side of the shipping container may be in the shape of a ladder.

### Effect of the Invention

In the constitution according to the present invention, the shipping container includes: a bottom plate onto which cargo is to be placed; columns vertically extending from the bottom plate; and a top plate detachably supported by the columns. Since the top plate of this shipping container is detachable from the columns, it is possible to smoothly load cargo from above the shipping container, by detaching and removing the top plate when loading the cargo into the shipping container. When the loading is completed, the top plate is attached back to the columns again. By attaching the top plate to the columns, the columns, which are separately and vertically disposed, are integrally joined together by the top plate, thereby ensuring the strength of the shipping container as a whole. Therefore, a plurality of such shipping containers can be stacked one on top of another in a container ship, in the same manner as ordinary shipping containers.

### BRIEF DESCRIPTION OF THE DRAWINGS

FIG. 1 is a perspective view of one embodiment of a shipping container according to the present invention.

FIG. 2 is a perspective view of the shipping container shown in FIG. 1, in a state in which its top plates are removed.

FIG. 3 is a front view of the shipping container of FIG. 1, illustrating an operation for removing the top plates.

FIGS. 4(a) and 4(b) are partial sectional views of the shipping container shown in FIG. 1, showing its locking mechanism, seen from the side: of which FIG. 4 (a) shows a locked state of the locking mechanism; and FIG. 4 (b) shows an unlocked state thereof.

FIG. 5 is a perspective view of the locking mechanism.

FIGS. 6(a)-6(c) are vertical sectional views of the locking mechanism: of which FIG. 6 (a) shows a state in which a column and the top plate are spaced apart from each other; FIG. 6 (b) shows a state in which the column and the top plate are unlocked from each other; and FIG. 6 (c) shows a state in which the column and the top plate are locked together.

FIG. 7 is a side view of the shipping container of FIG. 1, illustrating the process of loading of long objects into the shipping container.

FIG. 8 is a front view of the shipping container showing a state in which the long objects are fixed in position by wires.

### MODE FOR CARRYING OUT THE INVENTION

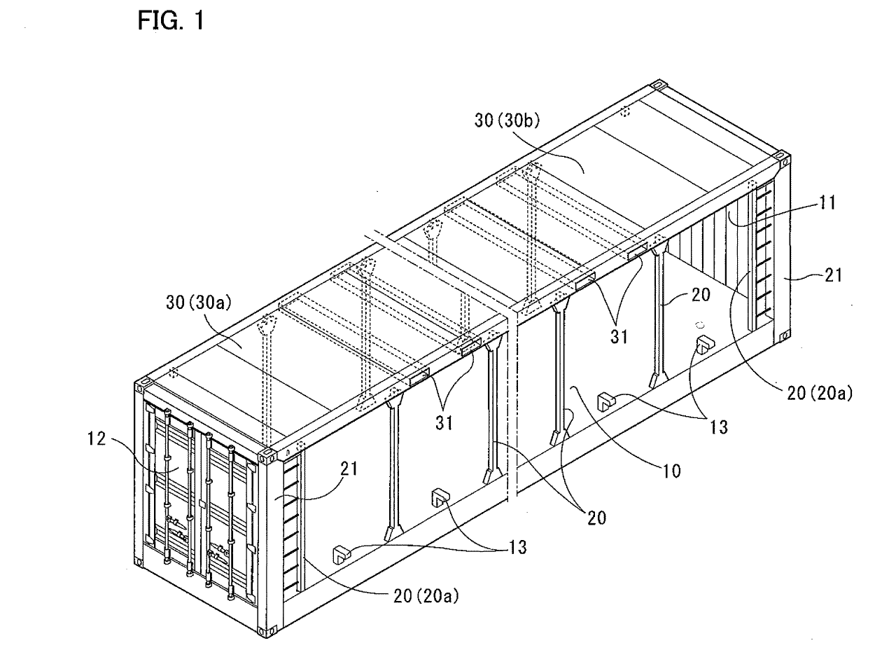

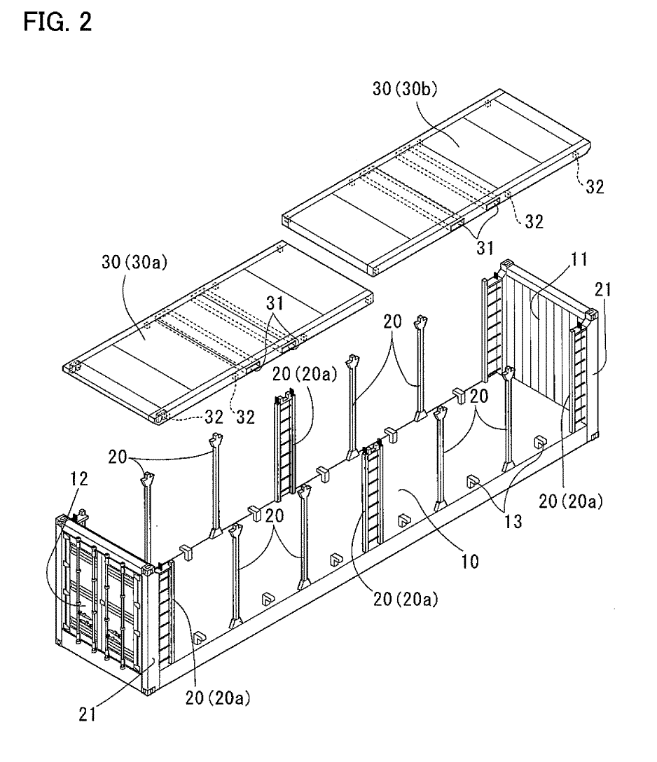

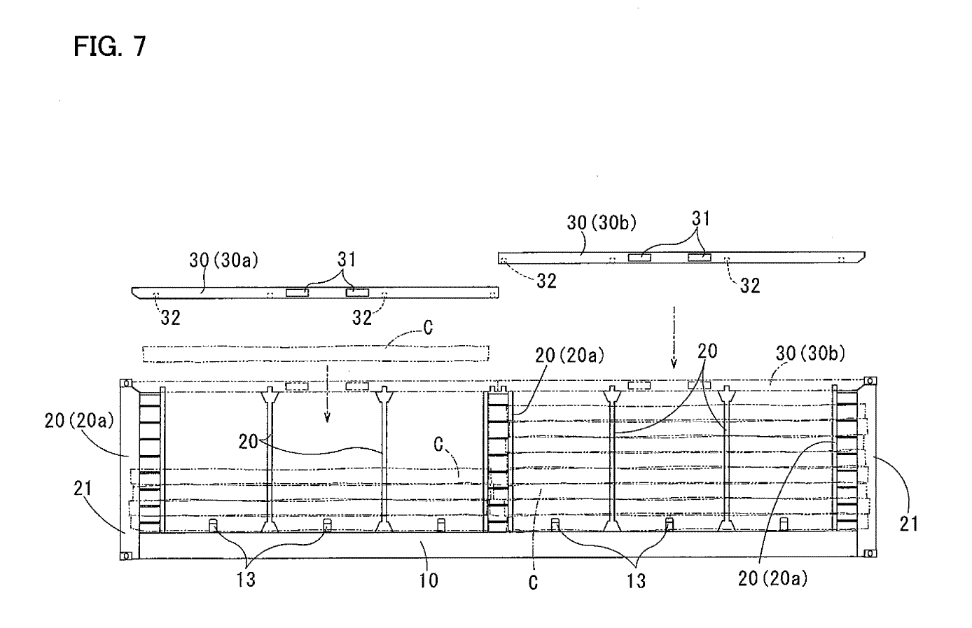

One embodiment of a shipping container according to the present invention is shown in FIG. 1 and FIG. 2. This shipping container includes, as main components, a bottom plate 10, columns 20, and top plates 30. Unlike an ordinary shipping container, this shipping container does not have side plates, and cargo C loaded within the shipping container can be seen through the openings between the columns 20 (see FIG. 7).

The bottom plate 10 is a plate member in the shape of a rectangle, on top of which the cargo C is to be placed. The size of a shipping container is defined by international standards, and the bottom plate 10 is generally 20 feet or 40 feet long, and 8 feet wide, in accordance with the size defined in the international standards. A front plate 11 extends vertically from the front edge of the bottom plate 10, doors 12, which can be opened and closed extend vertically from the rear edge of the bottom plate 10. Fixing jigs 13 are provided on both the right and left sides of the upper surface of the bottom plate 10, spaced apart from each other at predetermined intervals (for example, at 1 m intervals).

The columns 20 consist of 14 vertically extending columns, seven of which is disposed on each of the right and left sides of the bottom plate 10. Of the seven columns 20 on each side of the bottom plate 10, the columns 20 (20a) disposed at the foremost portion, the central portion and the rearmost portion of the bottom plate 10 are in the shape of a ladder. With this arrangement, an operator can easily check how the cargo C is loaded in the shipping container by climbing up one of the ladder-shaped columns 20 to the upper portion of the shipping container. Further, since the widths (lengths in the fore and aft direction) of the ladder-shaped columns 20 are usually larger than the widths of the other regular-shaped columns 20, it is possible to more stably hold the cargo C in the shipping container. The lengths of the columns 20 are usually adjusted such that the height of the shipping container (with the top plates 30 being attached) is 8 feet and 6 inches.

The number of the columns 20 is not limited, and may be varied taking into consideration the weight of the top plates 30, the required strength of the shipping container, and the like. The intervals between the adjacent pairs of columns 20 are preferably adjusted wider than the distance between the outer edges of the pair of forks of a commonly used forklift so that the cargo C can be easily loaded into the shipping container through its side, using a forklift. The columns 20 are preferably detachably attached to the bottom plate 10 so that the cargo C can be more easily loaded into the shipping container.

Engaging walls 21 are provided, respectively, at the front sides of the columns 20 (20a) disposed at the foremost portion of the shipping container (namely between the front plate 11 and the foremost columns 20 (20a)), and at the rear sides of the columns 20 (20a) disposed at the rearmost portion of the shipping container (namely between the doors 12 and the rearmost columns 20 (20a)). By providing the engaging walls 21, both the end portions of the cargo C placed within the shipping container can be supported in the lateral direction (particularly if the cargo C consists of long objects). Thus, the engaging walls 21 make the cargo C less likely to be inclined diagonally within the shipping container, thus preventing the load of the cargo C from being applied only to a particular one or ones of the columns 20. The widths (lengths in the fore and aft direction) of the engaging walls 21 are not limited, but are preferably from 30 to 80 cm.

While in the embodiment, the columns 20 (20a) at the foremost portion, central portion, and the rearmost portion of the shipping container are in the shape of a ladder, this is merely one example. That is, any one or ones of the 14 columns 20 may have the shape of a ladder, taking into consideration, for example, the convenience of checking how the cargo C is loaded in the shipping container. Alternatively, none of the columns 20 may have the shape of a ladder.

The top plates 30 cover the upper portion of the shipping container, and are detachable from the columns 20. The top plates 30 are two separate top plate members 30a and 30b each half the size of the bottom plate 10 ((10 feet or 20 feet long, and 8 feet wide). While two top plates 30, i.e., two separate top plate members 30a and 30b are used in this embodiment, a single integral top plate 30 may be used instead, if, for example, the shipping container has a short total length (e.g., 20 feet).

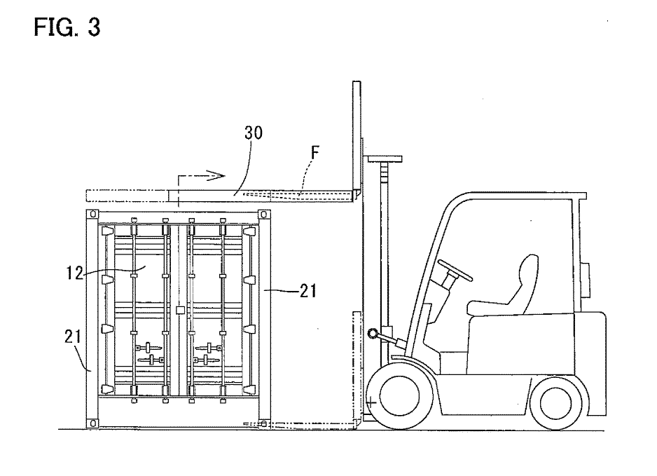

A pair of insertion recesses 31 are formed in each of the top plates 30 (separate top plate members 30a and 30b) to extend from side to side thereof. The interval between the pair of insertion recesses 31 is equal to the interval between the pair of forks F of the forklift shown in FIG. 3 so that the forks F of the forklift can be inserted into the insertion recesses 31 of each top plate 30 to elevate and lower the forks F, thereby allowing for easily attaching and detaching the top plate 30 (separate top plate member 30a, 30b) to and from the columns 20.

The top plates 30 (separate top plate members 30a and 30b) have, in the lower surfaces thereof, fitting recesses 32 at positions corresponding to the positions of the respective columns 20, and configured such that the upper ends of the columns 20 are fitted into the respective fitting recesses 32 (see FIG. 2). By fitting the upper ends of the respective columns 20 into the fitting recesses 32, it is possible, when the cargo C loaded within the shipping container leans against the columns 20, to prevent the columns 20 from significantly bending outwardly due to the load of the cargo C.

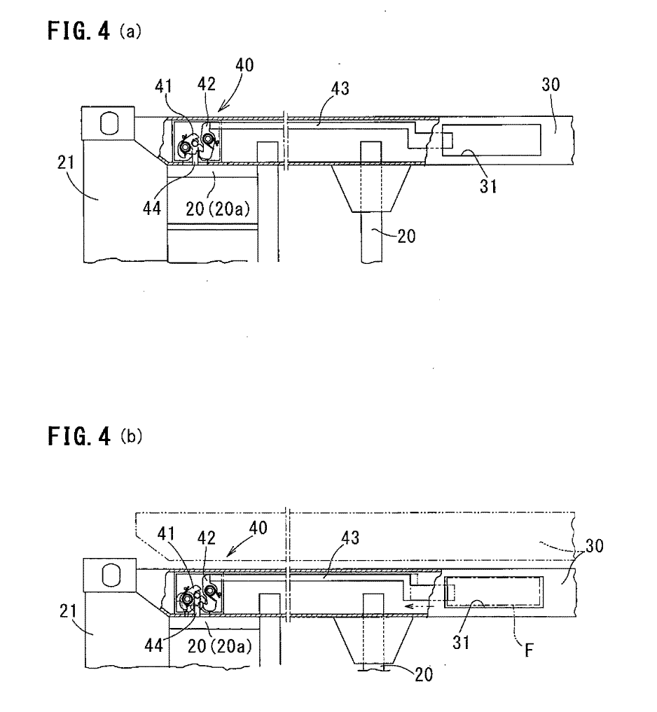

Further, as shown in FIG. 4, a locking mechanism 40 is provided at least at one corner of each top plate 30 (separate top plate member 30a, 30b). The locking mechanism 40 is configured such that when the top plate 30 is placed on the corresponding columns 20, and as a result, the top plate 30 is lowered and fitted to the columns 20 under its own weight, the locking mechanism 40 automatically locks the top plate 30 to the columns 20. The locking mechanism 40 is further configured to automatically unlock the top plate 30 from the columns 20 when the forks F of a forklift are inserted into the insertion recesses 31 formed in the top plate 30.

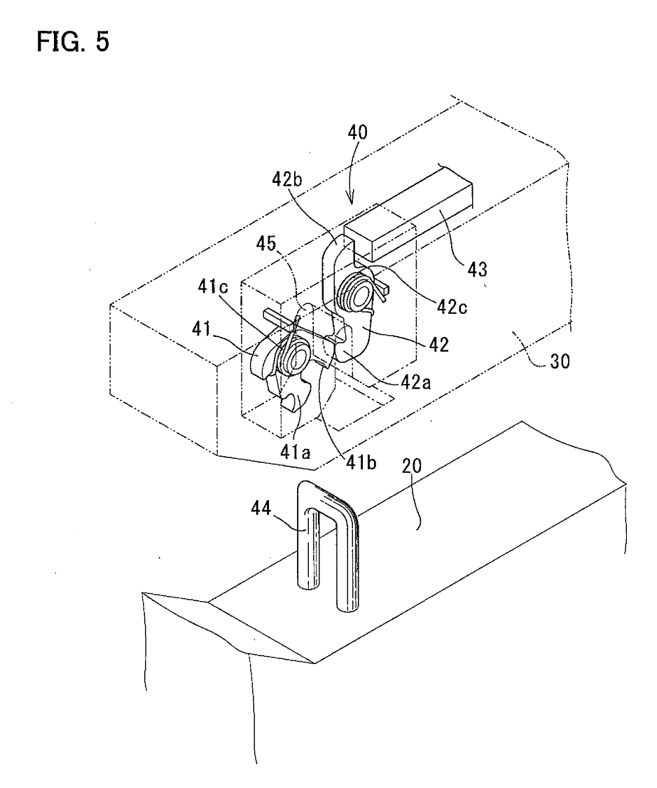

As shown in detail in FIG. 5, each locking mechanism 40 mainly includes: a first hook 41, a second hook 42, and an unlocking bar 43 that are provided on the top plate 30; and an engaging piece 44 provided on one of the columns 20. The first hook 41 is provided with a first engaging protrusion 41a and an engaging recess 41b, and is biased in one direction by a first biasing member 41c. The second hook 42 is provided with a second engaging protrusion 42a and an abutment portion 42b, and is biased by a second biasing member 42c in the one direction described above. The above described one direction is the clockwise direction in the figures, and the direction opposite to the above described one direction is the counterclockwise direction in the figures. The unlocking bar 43 extends into one of the insertion recesses 31 of the top plate 30, while being in abutment with the abutment portion 42b of the second hook 42, and is configured to be movable in the lateral direction.

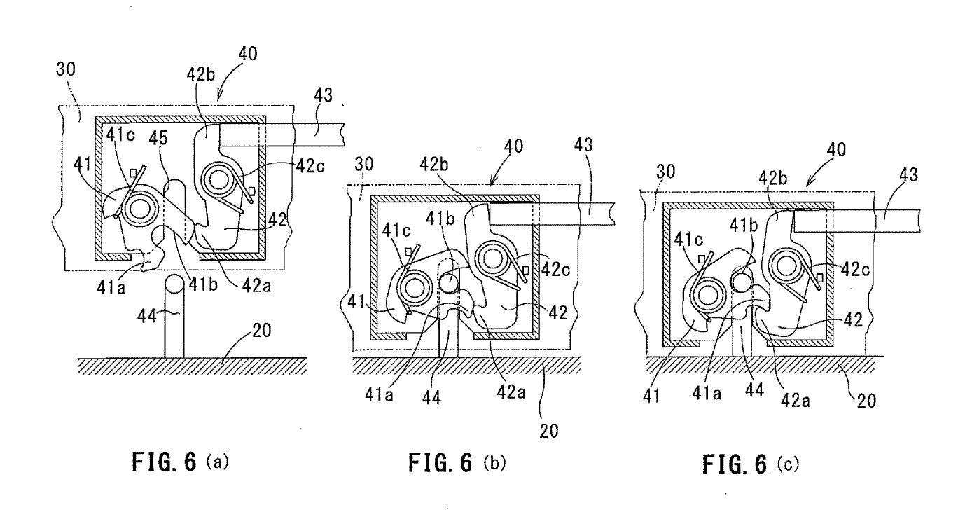

When the top plate 30 is lowered toward the columns 20, the engaging piece 44 is inserted into a slit portion 45 of the locking mechanism 40, and comes into contact with the inner surface of the engaging recess 41b. This causes the first hook 41 to be rotated in the counterclockwise direction against the biasing force of the first biasing member 41c (see FIGS. 6 (a) and (b)). When the engaging piece 44 is further inserted to a predetermined position, the second hook 42 is rotated in the clockwise direction under the biasing force of the second biasing member 42c, thereby allowing the first engaging protrusion 41a of the first hook 41 and the second engaging protrusion 42a of the second hook 42 to be engaged with each other. In this manner, the top plate 30 is locked to the corresponding column 20 (see FIG. 6 (c)).

In this state, i.e., with the top plate 30 locked to the column 20, when the forks F of a forklift are inserted into the insertion recesses 31 formed in the top plate 30, the unlocking bar 43 is moved toward the second hook 42 by the fork F inserted in the one of the insertion recesses 31, and the thus moved unlocking bar 43 pushes the abutment portion 42b of the second hook 42 in the counterclockwise direction. This causes the second hook 42 to rotate in the counterclockwise direction against the biasing force of the second biasing member 42c, and the engagement between the first engaging protrusion 41a of the first hook 41 and the second engaging protrusion 42a of the second hook 42 is released. In this manner, the top plate 30 is unlocked from the corresponding column 20 (see FIG. 6 (c) to (b)). When the top plate 30 is moved upward after being unlocked from the columns 20, the first hook 41 is rotated in the clockwise direction under the biasing force of the first biasing member 41c, and the engaging piece 44 disengages from the first hook 41 (see FIG. 6 (a)).

The configuration of the locking mechanisms 40 described above is merely an example, and it is also acceptable to provide other types of locking mechanisms, or to provide no locking mechanism at all.

By removing the top plates 30, it is possible, as shown in FIG. 7, to easily load long objects such as lumber and the like into the shipping container, from above the container, using a heavy equipment (not shown) such as a crane, or a forklift, thereby ensuring high operational efficiency. Further, since this shipping container can be stacked on other shipping containers in a container ship in the same manner as ordinary shipping containers, it is not necessary to unload the cargo which has been transported to the harbor by a truck, and reload it into a shipping container. This significantly reduces the steps and cost for loading cargo.

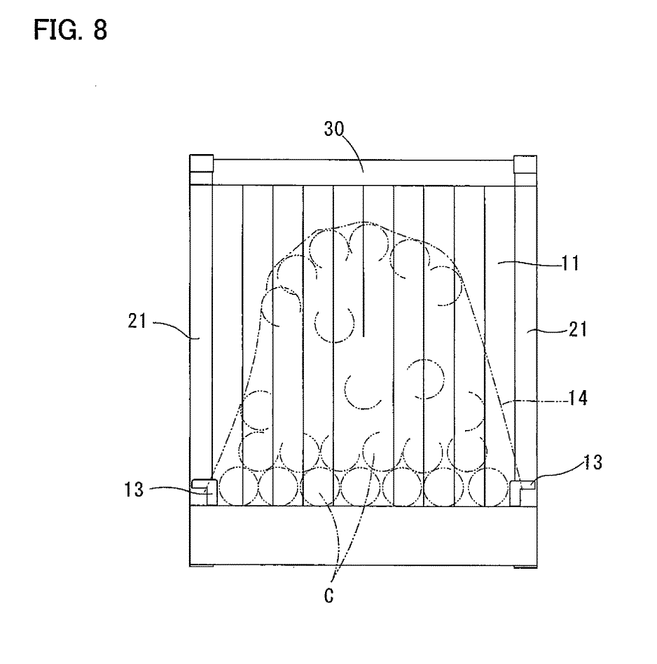

If the cargo C is long objects, wires 14 may be wrapped around the cargo C and hooked to the fixing jigs 13 on the right and left sides of the bottom plate to fix the cargo C, as shown in FIG. 8, so that the shifting of the cargo C during transportation can be prevented to enhance safety.

When importing and exporting raw wood, it is required that the raw wood be subjected to a disinfection treatment by fumigation, and be loaded into a ship, and the like, within a specified period of time (two weeks, for example) after the disinfection treatment. The fumigation treatment is carried out by: stacking the raw wood in a pile at a predetermined location; covering a sheet over the stacked raw wood, and sealing the circumference of the sheet; and then filling the sealed space enclosed by the sheet with gas for fumigation. If the raw wood has been transported in a shipping container or the like, the raw wood needs to be unloaded for the fumigation treatment. The reason for this is as follows. A common shipping container has corrugated side plates, and thus it is difficult to allow the gas for fumigation to fully spread within the interior of the shipping container. In addition, the extent to which the gas is spread and filled within the shipping container cannot be confirmed, making it difficult to stably carry out the fumigation operation. As described above, the necessity to unload the cargo significantly complicates the series of shipping operations, and makes it time-consuming as well as cost-consuming.

In contrast, when the shipping container according to the present invention is used, this fumigation operation can be carried out extremely smoothly and securely. In other words, although this shipping container does not have side plates, it is possible to easily seal the interior of the shipping container, by placing a sheet over the top plates 30 and covering the sides of the shipping container. In addition, by covering the shipping container by a sheet, it is possible to easily confirm the extent to which the gas for fumigation is spread and filled within the shipping container, and thus to adjust the amount of the gas to be introduced into the shipping container so that a uniform fumigation treatment can be performed. Further, if at least one of the columns 20 is in the shape of a ladder, an operator can climb up the ladder-shaped column 20 to the top of the shipping container, to smoothly carry out an operation for covering the shipping container with a sheet.

The above-described embodiment is merely an example, and the shape, the arrangement, the number and the like of the component members of the shipping container, such as the bottom plate 10, the columns 20, and the top plates 30 can be changed as appropriate, as long as it is possible to realize the object of the present invention, which is to provide a shipping container into which long objects such as lumber can be efficiently loaded.

### DESCRIPTION OF SYMBOLS

10 bottom plate
11 front plate
12 openable and closable doors
13 fixing jig
14 wire
20 (20a) column
21 engaging wall
30 top plate
30a, 30b divided top plate portion
31 insertion recess
32 fitting recess
40 locking mechanism
41 first hook
41a first engaging protrusion
41b engaging recess
41c first biasing member
42 second hook
42a second engaging protrusion
42b abutment portion
42c second biasing member
43 unlocking bar
44 engaging piece
45 slit portion
C cargo
F forks

1. A shipping container comprising:
a bottom plate onto which cargo is to be placed;
columns vertically extending from the bottom plate; and
a top plate detachably supported by the columns.

2. The shipping container according to claim 1, wherein the top plate is formed with an insertion recess configured such that a jig which is used to attach and detach the top plate to and from the columns is inserted into the insertion recess.

3. The shipping container according to claim 1, wherein one of the columns is in the shape of a ladder.

4. The shipping container according to claim 2, wherein one of the columns is in the shape of a ladder.
